(19) United States
(12) Patent Application Publication
(10) Pub. No.: US 2016/0327691 A1
(43) Pub. Date: Nov. 10, 2016

(54) POLARIZER AND MANUFACTURING METHOD THEREOF, DISPLAY PANEL AND DISPLAY DEVICE

(71) Applicant: BOE TECHNOLOGY GROUP CO., LTD., Beijing (CN)

(72) Inventors: Yue SHI, Beijing (CN); Guangkui QIN, Beijing (CN); Jikai YAO, Beijing (CN)

(73) Assignee: BOE TECHNOLOGY GROUP CO., LTD., Beijing (CN)

(21) Appl. No.: 14/905,500

(22) PCT Filed: Jul. 16, 2015
(86) PCT No.: PCT/CN2015/084171

§ 371 Date: Jan. 15, 2016

(30) Foreign Application Priority Data
Dec. 26, 2014 (CN) 201410832102.X

(51) Int. Cl. G02B 1/16; G02B 5/30; G02F 1/1335; G02B 1/14

(52) U.S. Cl. CPC G02B 1/16; G02B 1/14; G02B 5/3033; G02F 1/133528

(57) ABSTRACT

A polarizer and a manufacturing method thereof, a display panel and a display device are provided. The polarizer comprises a first protective layer (1) and a conductive layer (2) arranged on the first protective layer (1), and a material of the conductive layer (2) includes graphene. The polarizer is applied to a manufacturing technology of a display, solves a problem of possible electrostatic breakdown of a display device, avoids use of rare metal, reduces production cost, ensures performance of the display device and meets a matching degree of a process.

### TECHNICAL FIELD

Embodiments of the present disclosure relate to a polarizer and a manufacturing method thereof, a display panel and a display device.

### BACKGROUND

Usually, according to a display mode, a liquid crystal panel may be divided into a Twisted Nematic (TN) type, an In Plane Switching (IPS) type and an Advanced Super Dimensional Switching (ADS) type. In liquid crystal displays of ADS type and IPS type, a common electrode and a pixel electrode providing a voltage for driving liquid crystal to deflect are arranged on an array substrate, and a deflection degree of liquid crystal molecules is controlled by an electric field generated between the common electrode and the pixel electrode. Therefore, no electrode on a color filter substrate performs a function of protecting the liquid crystal molecules. When a user contacts a liquid crystal screen, particularly a touch screen from a side of the color filter substrate, static electricity may be transferred to the liquid crystal screen, and electrostatic breakdown may occur.

In order to avoid electrostatic breakdown, generally a layer of transparent conductive Indium Tin Oxide (ITO) is prepared on an outer side of a Color Filter (CF) substrate. However, ITO contains rare metal indium, resulting in increase of production cost, or even a problem of using up the rare metal indium many years later, thereby influencing performance of a final display device. If the material is replaced, a problem of mismatching with a liquid crystal panel process may further occurs.

### SUMMARY

At least one embodiment of the present disclosure provides a polarizer and a manufacturing method thereof, a display panel and a display device, which are capable of solving the problem of electrostatic breakdown of a display device, avoiding use of rare metal, reducing a production cost, ensuring performance of the display device and meeting the matching degree of a process.

At least one embodiment of the present disclosure provides a polarizer, comprising a first protective layer and a conductive layer arranged on the first protective layer, wherein, a material of the conductive layer includes graphene.

For example, the polarizer further comprises a second protective layer and a polarized layer sandwiched between the first protective layer and the second protective layer, wherein, the conductive layer is arranged on a surface of the first protective layer away from the polarized layer.

For example, the polarizer further comprises a second protective layer and a polarized layer sandwiched between the first protective layer and the second protective layer, wherein, the conductive layer is arranged between the first protective layer and the polarized layer.

For example, the conductive layer has a thickness of 3-10 Å.

At least one embodiment of the present disclosure further provides a display panel; the display panel comprises a first polarizer, and a first substrate and a second substrate cell-assembled with each other, the first substrate being close to a light exiting surface, and the second substrate being close to a backlight surface, wherein, the first polarizer is the polarizer according to the first aspect; the first polarizer is arranged on a surface of the first substrate away from the second substrate.

For example, the display panel further comprises: a second polarizer, formed on a surface of the second substrate away from the first substrate, and covering the second substrate; wherein, the second polarizer includes two protective layers and a polarized layer sandwiched between the protective layers.

At least one embodiment of the present disclosure further provides a manufacturing method of a polarizer, and the method comprises: forming a conductive layer on a support layer; forming a first protective layer on a side of the conductive layer away from the support layer; removing the support layer; forming a polarized layer on the first protective layer; forming a second protective layer on the polarized layer; wherein, a material of the conductive layer includes graphene.

At least one embodiment of the present disclosure further provides a manufacturing method of a polarizer, and the method comprises: forming a conductive layer on a first protective layer; forming a polarized layer on the conductive layer; forming a second protective layer on the polarized layer; wherein, a material of the conductive layer includes graphene.

For example, the conductive layer is a conductive layer with a copper substrate, and the forming a conductive layer on a first protective layer includes: bonding the first protective layer to a side of the conductive layer away from the copper substrate by a bonding process. For example, the forming the polarized layer on the conductive layer includes: bonding the polarized layer on a side of the first protective layer away from the conductive layer, and etching out the copper substrate in the conductive layer.

For example, after the bonding the first protective layer to a side of the conductive layer away from the copper substrate by a bonding process, the method further comprises etching out the copper substrate in the conductive layer.

For example, the forming the polarized layer on the conductive layer includes bonding the conductive layer and the polarized layer.

At least one embodiment of the present disclosure further provides a display device, and the display device comprises any polarizer described above, or any display panel described above.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a structural schematic diagram of a polarizer provided by an embodiment of the present disclosure;

FIG. 2 is a structural schematic diagram of another polarizer provided by an embodiment of the present disclosure;

FIG. 3 is a structural schematic diagram of still another polarizer provided by an embodiment of the present disclosure;

FIG. 4 is a structural schematic diagram of a display panel provided by an embodiment of the present disclosure;

FIG. 5 is a structural schematic diagram of another display panel provided by an embodiment of the present disclosure;

FIG. 6 is a structural schematic diagram of still another display panel provided by an embodiment of the present disclosure;

FIG. 7 is a structural schematic diagram of a display panel provided by another embodiment of the present disclosure;

FIG. 8a and FIG. 8b are flow schematic diagrams of a manufacturing method of a polarizer provided by an embodiment of the present disclosure;

FIG. 8c is a flow schematic diagram of forming a first protective layer covering a conductive layer on the conductive layer provided by an embodiment of the present disclosure;

FIG. 9a and FIG. 9b are flow schematic diagrams of another manufacturing method of a polarizer provided by an embodiment of the present disclosure;

FIG. 10 is a flow schematic diagram of still another manufacturing method of a polarizer provided by an embodiment of the present disclosure.

Reference signs: 1—First protective layer; 2—Conductive layer; 3—Second protective layer; 82,4—Polarized layer; 5—First substrate; 6—Second substrate; 7—First polarizer; 8—Second polarizer; 81—Protective layer; 9—Support layer; 10—Copper substrate.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

Unless otherwise defined, technical or scientific terms used herein should have general meanings understood by those ordinarily skilled in the art. “First”, “second” and similar words used in the present disclosure do not represent any sequence, quantity or importance and merely intend to differentiate different composite parts.

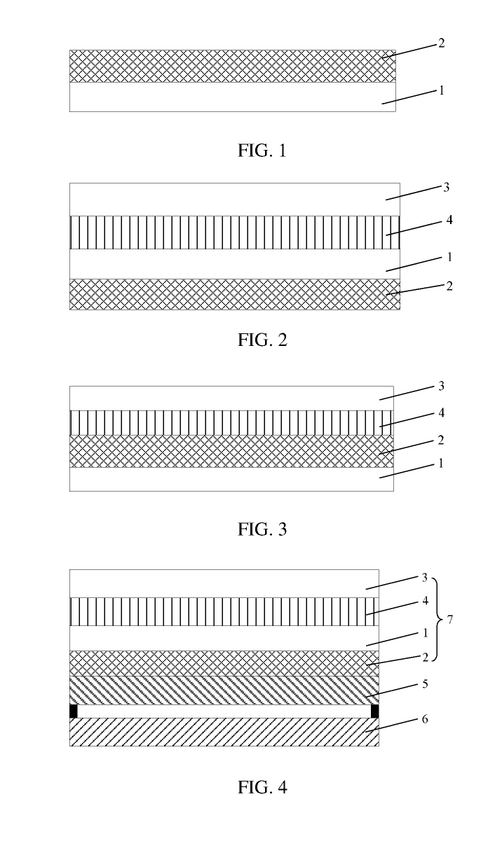

At least one embodiment of the present disclosure provides a polarizer; as shown in FIG. 1, the polarizer comprises a first protective layer 1 and a conductive layer 2, wherein, the conductive layer 2 is arranged on the first protective layer 1. A material of the conductive layer 2 includes graphene.

With the polarizer provided in an embodiment of the present disclosure, the conductive layer is manufactured on the first protective layer of the polarizer by using graphene material, the graphene conductive layer is integrated into the polarizer without increasing a technological difficulty, and a problem of consuming the rare metal is avoided. When a user adopts a display panel with the polarizer, static electricity in the display panel can be timely released, a problem of electrostatic breakdown possibly occurring in a display device can be avoided, the rare metal is not used, a production cost is reduced, and performance of the display device is ensured.

Further, as shown in FIG. 2, the polarizer may further comprise a second protective layer 3 and a polarized layer 4 sandwiched between the first protective layer 1 and the second protective layer 3, wherein, the conductive layer 2 is arranged on a surface of the first protective layer 1 away from the polarized layer 4.

For example, in the embodiment of the present invention, the conductive layer of graphene material arranged on a surface of the first protective layer away from the polarized layer may be implemented by a method as follows: forming graphene with a copper substrate in a chemical vapor deposition furnace, then cutting it to make it have a desired size by a cutting machine, and then spin-coating a transfer medium, such as, Polymethyl Methacrylate (PMMA) on a surface of the graphene, etching the copper substrate by an etching device, and bonding a film layer having the graphene and the transfer medium and the first protective layer in the polarizer. Meanwhile, a graphene transfer device is thoroughly cleaned by adopting a cleaning device, and then the transfer medium is peeled after cleaning. Hence, the graphene is formed on the surface of the first protective layer away from the polarized layer.

It needs to be explained that in order to etch out the copper substrate by the etching device, during spin-coating the PMMA, the PMMA is coated on a side of the graphene away from the copper substrate. Similarly, when the film layer having the graphene and the transfer medium PMMA is bonded to the first protective layer in the polarizer, in order to ensure successfully peeling of the PMMA and no peeling of the graphene, a side of the PMMA with the graphene is bonded to the first protective layer.

Further, for example, the protective layer may be used as a transfer medium of the graphene in above process; as shown in FIG. 3, it is illustrated by taking an example that the conductive layer 2 is arranged between the first protective layer and the polarized layer 4, such that the conductive layer is better protected against external damage. It needs to be explained that the conductive layer 2 may also be arranged on a side of the first protective layer 1 away from the polarized layer 4.

For example, the conductive layer made of the graphene material may be arranged on a surface of the first protective layer close to the polarized layer. A method for forming the graphene conductive layer in an embodiment may be: bonding the first protective layer and a graphene film with the copper substrate, then bonding the polarized layer, and etching out the copper substrate in the graphene film when the polarized layer is bonded. In a process of forming the graphene film, the first protective layer may be used as a transfer medium. Hence, it is unnecessary to remove the transfer medium from the finally formed graphene film, and the graphene conductive layer is formed in a process of forming the polarizer, thus decreasing a production process, greatly reducing a production cost and decreasing wastes in production. Meanwhile, the conductive layer 2 is arranged between the first protective layer 1 and the polarized layer 4, and the conductive layer 2 can be protected from damage.

For example, the conductive layer may have a thickness of 3 Å-10 Å.

For example, a graphene conductive layer is manufactured on the first protective layer in the polarizer in an embodiment of the present disclosure to replace a common ITO conductive layer, so that the rare metal indium is not used. Meanwhile, since the graphene film can increase an area of the conductive layer, static electricity generated in a process of using the display device by a user can be timely released, an electrostatic breakdown phenomenon is finally avoided, and meanwhile a case that the material for forming the conductive layer is used up is avoided.

With the polarizer provided in the embodiment of the present disclosure, a conductive layer is manufactured on the first protective layer of the polarizer by using a graphene material, the graphene conductive layer is formed in the polarizer without increasing a technological difficulty, and the rare metal is not consumed. Meanwhile, when the user adopts a display panel with the polarizer, static electricity generated in the display panel can be timely released. A problem of electrostatic breakdown of the display device can be avoided, the rare metal is not used, a production cost is reduced and performance of the display device is ensured.

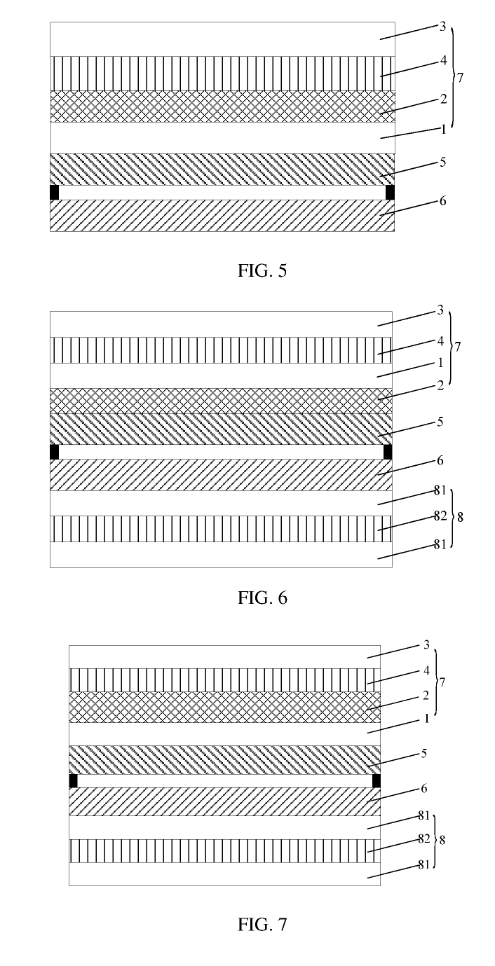

At least one embodiment of the present disclosure provides a display panel; as shown in FIG. 4 and FIG. 5, the display panel comprises: a first substrate 5 and a second substrate 6 cell-assembled with each other, and a first polarizer 7, the first substrate 5 being close to a light exiting surface and the second substrate 6 being close to a backlight surface, wherein: The first polarizer 7 is any polarizer provided in the above embodiments.

The first polarizer 7 is arranged on a surface of the first substrate 5 away from the second substrate 6.

For example, the polarizer provided in the present embodiment may be applicable to display panels of IPS type and ADS type. One feasible implementation mode is that the first substrate is an array substrate and the second substrate is an opposed substrate. Namely, the conductive layer made of the graphene material may be arranged in a layer structure of the first polarizer on a surface of the opposed substrate away from the array substrate or on a side of the opposed substrate away from the array substrate.

It needs to be explained that the opposed substrate and the array substrate are oppositely arranged, and are upper and lower substrates of the display panel, respectively; generally, a display structure such as a thin-film transistor array is formed on the array substrate, and color filter is formed on the opposed substrate. For example, the opposed substrate is a color filter substrate, but is not limited thereto.

Further, as shown in FIG. 6 or FIG. 7, the display panel further comprises: a second polarizer 8 formed on a surface of the second substrate 6 away from the first substrate 5 and covering the second substrate 6.

For example, the second polarizer 8 includes two protective layers 81 and a polarized layer 82 sandwiched between the protective layers 81.

Of course, the second polarizer may further includes a conductive layer, which is arranged between the protective layer close to the second substrate sand the polarized layer or a surface, away from the polarized layer, of a TAC material layer close to the second substrate.

With the display panel provided in an embodiment of the present disclosure, a conductive layer made of a graphene material is manufactured on the first protective layer of the polarizer in the display panel by using a graphene material, so that the graphene conductive layer and the polarizer are manufactured together without increasing a technological difficulty. And the rare metal is not consumed. Meanwhile, when the user adopts a display panel with the polarizer, static electricity generated in the display panel can be timely released. Possible electrostatic breakdown of a display device can be avoided, use of the rare metal is avoided, a production cost can be reduced and performance of the display device is ensured.

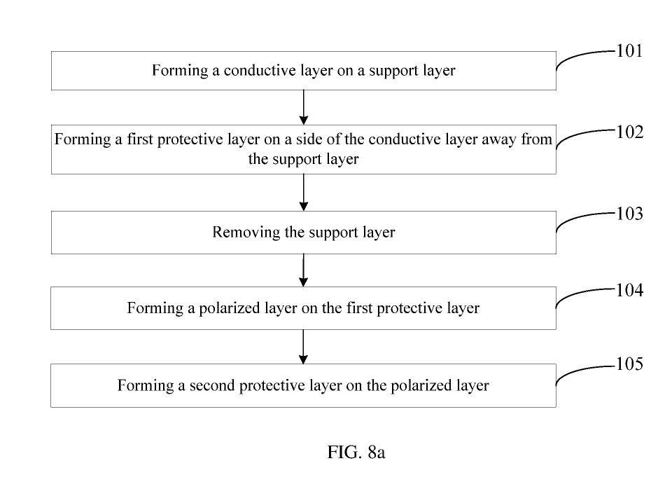

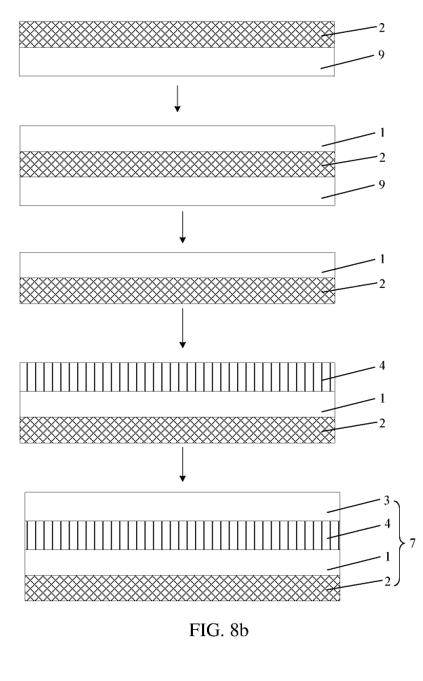

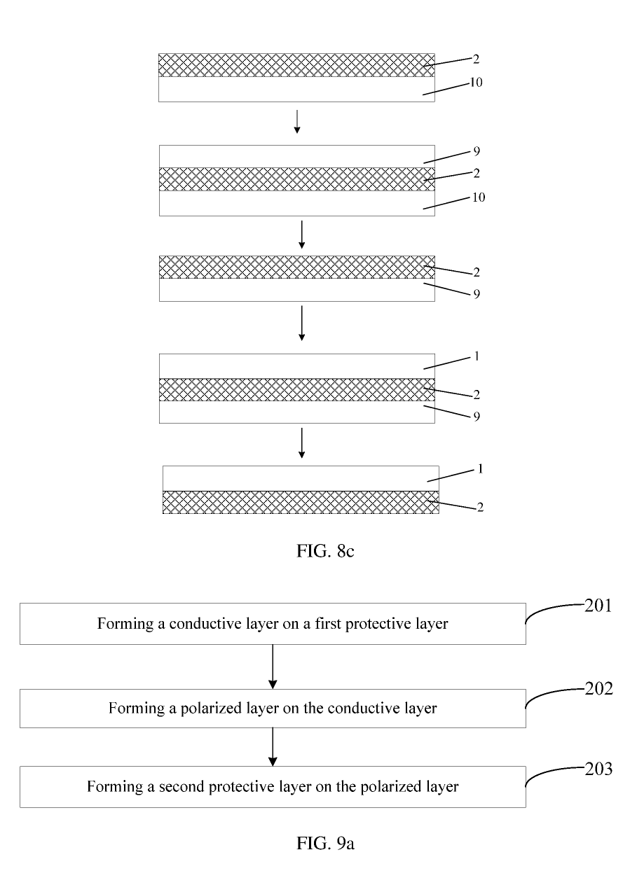

An embodiment of the present disclosure provides a manufacturing method of a polarizer; as shown in FIG. 8a and FIG. 8b, the method comprises steps of:

101: Forming a conductive layer 2 on a support layer 9.

102: Forming a first protective layer 1 covering the conductive layer 2 on a side of the conductive layer 2 away from the support layer 9.

Wherein a material of the conductive layer includes graphene and the conductive layer may have a thickness of 3-10 Å.

103: Removing the support layer 9.

For example, as shown in FIG. 8c, the graphene conductive layer 2 with a copper substrate 10 is formed in a chemical vapor deposition furnace and is then cut to a desired size by a cutting machine, a transfer medium, such as, Polymethyl Methacrylate (PMMA) is spin-coated on a surface of the graphene as the support layer 9, the copper substrate therein 10 is etched out by an etching device, and a film layer having the graphene and the transfer medium is bonded to the first protective layer in the polarizer. Meanwhile, a graphene transfer device is thoroughly cleaned by adopting a cleaning device, and after cleaning, the transfer medium, namely the support layer, is peeled, and thus, the first protective layer 1 covering the conductive layer 2 is formed on the conductive layer 2.

104: Forming a polarized layer 4 on the first protective layer 1.

105: Forming a second protective layer 3 on the polarized layer 4.

It needs to be explained that a formation process in step 104 and step 105 may refer to a process of forming the polarizer in a common design, which is not repeated herein.

With the manufacturing method of a display panel provided in an embodiment of the present disclosure, a conductive layer is formed on the first protective layer of the polarizer by using a graphene material, the graphene conductive layer and the polarizer are manufactured together without increasing a technological difficulty. And the rare metal is not consumed. Meanwhile, when the user adopts a display panel with the polarizer, static electricity generated in the display panel can be timely released. Possible electrostatic breakdown of a display device can be avoided, use of the rare metal can be avoided, a production cost can be reduced and performance of the display device can be ensured.

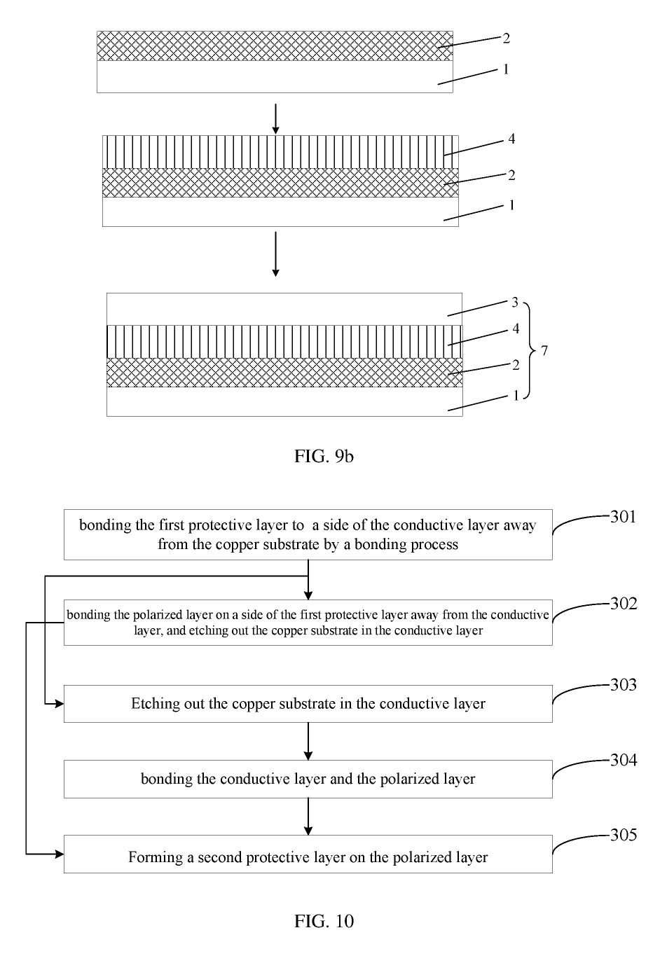

An embodiment of the present disclosure provides a manufacturing method of a polarizer; as shown in FIG. 9a and FIG. 9b, the method comprises steps of:

201: Forming a conductive layer 2 on a first protective layer 1.

Wherein, a material of the conductive layer includes graphene.

For example, the conductive layer has a thickness of 3-10 Å, and the graphene conductive layer may be bonded while the first protective layer is bonded, so as to form the graphene conductive layer on the first protective layer.

202: Forming a polarized layer 4 on the conductive layer 2.

203: Forming a second protective layer 3 on the polarized layer 4.

It needs to be explained that a formation process in step 203 may refer to a process of forming the polarizer in a common design, which is not repeated herein.

With the manufacturing method of a polarizer provided in an embodiment of the present disclosure, a conductive layer is formed on the first protective layer of the polarizer by using a graphene material, so that the graphene conductive layer and the polarizer are manufactured together without increasing a technological difficulty. And the rare metal is not consumed. Meanwhile, when the user adopts a display panel with the polarizer, static electricity generated in the display panel can be timely released. Possible electrostatic breakdown of a display device can be avoided, use of the rare metal can be avoided, a production cost can be reduced and performance of the display device can be ensured.

An embodiment of the present disclosure provides a manufacturing method of a polarizer; as shown in FIG. 10, the method comprises steps of:

301: Bonding the first protective layer to a side of the conductive layer away from the copper substrate by a bonding process.

For example, in a bonding process of the graphene conductive layer with the copper substrate, the first protective layer may serve as a transfer medium of forming the graphene conductive layer, and thus, less foreign substances are added, and a production process is decreased. It should be understood that after the first protective layer is adopted as a transfer medium of the graphene conductive layer, because a TAC layer as part of the polarizer needs not to be removed, the graphene conductive layer may be smoothly formed at a position on the TAC layer close to or away from the polarized layer.

For example, after step 301, step 302 or steps 303-304 may be executed selectively according to different manufacturing processes;

302: Bonding the polarized layer on a side of the first protective layer away from the conductive layer, and etching out the copper substrate in the conductive layer.

For example, in a device for implementing a bonding process of the polarizer layer, the copper substrate previously formed in graphene conductive layer is etched out, so that while an additional production process is avoided, a graphene conductive layer without impurity can be formed.

303: Etching out the copper substrate in the conductive layer.

304: Bonding the conductive layer and the polarized layer.

Step 305 is executed after step 302 or step 304 to form a second protective layer.

305: Forming a second protective layer on the polarized layer.

It needs to be explained that a formation process of the second protective layer in step 305 may refer to a process of forming the polarizer in a common design, which is not repeated herein.

With the manufacturing method of a polarizer provided in an embodiment of the present disclosure, a conductive layer is formed on the first protective layer of the polarizer by using a graphene material, so that the graphene conductive layer and the polarizer are manufactured together without increasing a technological difficulty, and a graphene production process and a polarizer production process can be fully matched to reduce the technological difficulty. And the rare metal is not consumed. Meanwhile, when the user adopts a display panel with the polarizer, static electricity generated in the display panel can be timely released. Possible electrostatic breakdown of a display device can be avoided, use of the rare metal can be avoided, a production cost can be reduced and performance of the display device can be ensured.

An embodiment of the present disclosure provides a display device, comprising any display panel provided in the embodiments corresponding to FIG. 4-FIG. 7 in the drawings; or the display device comprises any polarizer provided in the embodiments corresponding to FIG. 1-FIG. 3 in the drawings.

According to the display device provided in an embodiment of the present disclosure, a conductive layer is formed on the first protective layer of the polarizer in the display panel of the display device by using a graphene material, so that the graphene conductive layer and the polarizer are manufactured together without increasing a technological difficulty, a graphene production process and a polarizer production process are fully matched, the process difficulty is reduced and the rare metal is not consumed; meanwhile, when the user adopts a display panel with the polarizer, static electricity generated in the display panel can be timely released, possible electrostatic breakdown of a display device can be avoided, use of the rare metal can be avoided, a production cost can be reduced and performance of the display device can be ensured.

It needs to be explained in all embodiments of the present disclosure, it is illustrated by taking an example that the first protective layer and the second protective layer may be made of a material of Triacetyl Cellulose (TAC), and the polarized layer may be made of a material of Poly Vingl Alcohol (PVA), but is not limited thereto.

With the polarizer and the manufacturing method thereof, the display panel and the display device provided in embodiments of the present disclosure, a conductive layer is formed on the first protective layer of the polarizer by using a graphene material, so that the graphene conductive layer and the polarizer are manufactured together without increasing a technological difficulty, and the rare metal is not consumed; meanwhile, when the user adopts a display panel with the polarizer, static electricity generated in the display panel can be timely released, possible electrostatic breakdown of a display device can be avoided, use of the rare metal can be avoided, a production cost can be reduced and performance of the display device can be ensured.

It needs to be explained that without conflict, the embodiments and characteristics of the embodiments in the present disclosure may be combined.

The foregoing embodiments merely are specific implementation modes of the present disclosure, but a protection scope of the present disclosure is not limited thereto, changes or replacements easily conceived by any skilled in art within the technical scope disclosed by the present disclosure should be covered by the protection scope of the present disclosure. Therefore, the protection scope of the present disclosure is determined by a protection scope of claims.

The application claims priority of Chinese Patent Application No. 201410832102.X filed on Dec. 26, 2014, the disclosure of which is incorporated herein by reference in its entirety as part of the present application.

1. A polarizer, comprising a first protective layer and a conductive layer arranged on the first protective layer, wherein, a material of the conductive layer includes graphene.

2. The polarizer according to claim 1, further comprising a second protective layer and a polarized layer sandwiched between the first protective layer and the second protective layer, wherein, the conductive layer is arranged on a side of the first protective layer away from the polarized layer.

3. The polarizer according to claim 1, further comprising a second protective layer and a polarized layer sandwiched between the first protective layer and the second protective layer, wherein, the conductive layer is arranged between the first protective layer and the polarized layer.

4. The polarizer according to claim 1, wherein, the conductive layer has a thickness of 3 Å-10 Å.

5. A display panel, comprising a first polarizer according to claim 1, and a first substrate and a second substrate cell-assembled with each other, the first substrate being close to a light exiting surface, and the second substrate being close to a backlight surface, wherein the first polarizer is arranged on a surface of the first substrate away from the second substrate.

6. The display panel according to claim 5, further comprising:
a second polarizer, formed on a surface of the second substrate away from the first substrate, and covering the second substrate;
wherein, the second polarizer includes two protective layers and a polarized layer sandwiched between the two protective layers.

7. A manufacturing method of a polarizer, comprising:
forming a conductive layer on a support layer;
forming a first protective layer on a side of the conductive layer away from the support layer;
removing the support layer;
forming a polarized layer on the first protective layer;
forming a second protective layer on the polarized layer;
wherein, a material of the conductive layer includes graphene.

8. A manufacturing method of a polarizer, comprising:
forming a conductive layer on a first protective layer;
forming a polarized layer on the conductive layer;
forming a second protective layer on the polarized layer;
wherein, a material of the conductive layer includes graphene.

9. The method according to claim 8, wherein, the conductive layer is a conductive layer with a copper substrate, and the forming a conductive layer on a first protective layer includes:
bonding the first protective layer to a side of the conductive layer away from the copper substrate by a bonding process.

10. The method according to claim 9, wherein, the forming the polarized layer on the conductive layer includes:
bonding the polarized layer on a side of the first protective layer away from the conductive layer, and etching out the copper substrate in the conductive layer.

11. The method according to claim 9, after the bonding the first protective layer to a side of the conductive layer away from the copper substrate by a bonding process, further comprising etching out the copper substrate in the conductive layer.

12. The method according to claim 11, wherein, the forming the polarized layer on the conductive layer includes bonding the conductive layer and the polarized layer.

13. A display device, comprising the display panel according to claim 5.
